(19) United States
(12) Patent Application Publication
(10) Pub. No.: US 2002/0103869 A1
(43) Pub. Date: Aug. 1, 2002

(54) Standards development package method and system

(76) Inventors: Philip Goatly, Chelmsford (GB); Peter Brooks, West Sussex (GB)

Correspondence Address: Pillsbury Winthrop LLP, Intellectual Property Group, 50 Fremont Street, San Francisco, CA, 94105-2228, US

(21) Appl. No.: 09/885,474

(22) Filed: Jun. 20, 2001

Related U.S. Application Data
(60) Provisional application No. 60/216,852, filed on Jul. 7, 2000.

(51) Int. Cl. G06F 15/16; G06F 15/00; G06F 17/00

(52) U.S. Cl. 709/206; 707/513

(57) ABSTRACT

A method and apparatus that generate business documents and specifications compliant with modeled business components. The business concepts are modeled in Unified Modeling Language (UML). The UML models are analyzed and modeled as Hierarchical Structure Definition (HSD). Documents and document specifications can then be generated in HSD and plain language formats. Documents can also be compared against generated Document Type Definitions to determine compliance of the documents against UML models.

### BACKGROUND

1. Field of the Invention

Aspects of the present invention relate in general to a standards development package that facilitates the development, maintenance, understanding and enforcement of electronic data interchange conventions and standards that enable users to exchange commercial data electronically through the usage of common standards that are applied multilaterally. The system models business concepts, generates business reports, and verifies that reports and other documents comply with the modeled business concepts, thus allowing the documents and data to be exchanged electronically.

2. Description of the Related Art

In business, paper documents are often shared between different groups. For example, a bill of lading may be created to describe cargo shipped between a sender, a carrier, and a receiver. Conventionally, a person at each organization must take the paper bill of lading document and enter the document information into a computer. Thus, in the above example transaction, one set of document data must entered into three different computer systems at least three times. As each data entry person inputs the data into a system, the possibility that the information is entered incorrectly somewhere along the line is increased.

More importantly, information recorded on one paper document is often relevant to other documents involved with the same transaction. For example, a bill of lading may contain the same information as a purchase order for the same transaction. Conventionally, a data entry person may be required to enter this same information over again, adding to the overhead and generally inefficiency of a system.

Therefore, what is needed is a system and method that allows document information to be input once into a system, communicated electronically to others requiring use of the document data, and allows the information to be used across documents within the system.

### BRIEF DESCRIPTION OF THE DRAWINGS

FIG. 1 depicts a system that exchanges documents and document data seamlessly via a network.

FIG. 2 illustrates an overview embodiment of a process that models business components and documents, generates business reports, and verifies compliance of documents with business models, so that documents and document data may be exchanged seamlessly between parties.

FIG. 3 is a block diagram of an apparatus that models business concepts, generates business reports, and verifies compliance of documents with business models.

FIG. 4 is a functional block diagram of an apparatus that models business concepts, generates business reports, and verifies compliance of documents with business models.

FIG. 5 depicts a method embodiment that models business components.

FIGS. 6A-F are diagrams that illustrate the modeling of business components in a bill of lading.

FIGS. 7A-C depicts a flowchart of a method embodiment that extracts modeled business components, storing the modeled components as objects in database tables.

FIGS. 8A-B depicts a flowchart of a method embodiment that generates a hierarchical structure definition (HSD) validation script based on business models.

FIGS. 9A-B depict a flowchart of a method that validates an electronic document's compliance with the business model as represented by a hierarchical structure definition (HSD) validation script.

FIG. 10 depicts a flowchart of a method that displays layout and configures validation rules of elements of a specific document standard specification based on configuration attributes contained in a HSD and a set of default rules.

FIG. 11 flowcharts a method embodied by a hierarchical structure definition analyzer that allows users to familiarize themselves with the electronic data interchange conventions and standards and add or alter mapping text or code, as well as generate a document that is compliant with the standard from a HSD.

FIG. 12 illustrates a block diagram of various data types.

FIGS. 13A-D depict an example hierarchy, and representations of the example hierarchy as a hierarchy table, a generated table, and a HSD (schematic) output.

FIGS, 14A-B illustrate a flowchart of a method embodiment that generates plain language document specifications and abbreviated summaries of document specifications from a database model.

FIG. 15 depicts a flowchart of a version control method that insures the accuracy of a hierarchical structure definition.

FIGS. 16A-B illustrate a flowchart of a comparison method that compares hierarchical structure definitions.

FIG. 17 depicts an example embodiment of a hierarchical structure definition analyzer that allows users to view structure and semantics, add mapping text, add mapping code, or generate documents based on a hierarchical structure definition.

### DETAILED DESCRIPTION

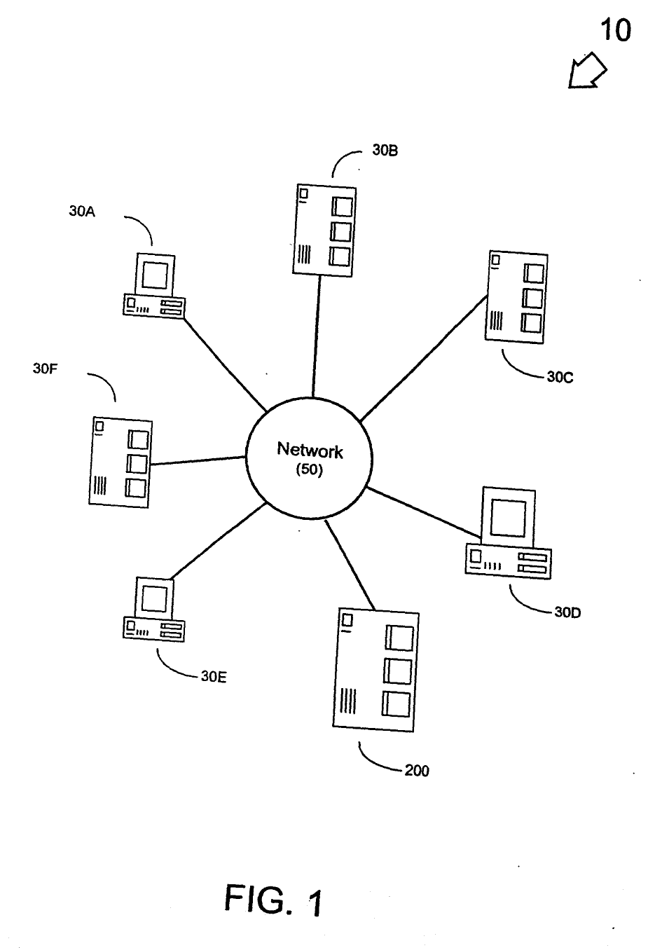

FIG. 1 is a simplified diagram depicting system 10, constructed and operative in accordance with an embodiment of the present invention. System 10 comprises a trusted client messaging server 200 networked with a plurality of client computing devices 30A-F. Client messaging server 200 facilitates the electronic communication of documents, and the data therein, between differing client computing devices 30A-F.

Client computing devices 30A-F may be any computing device known in the art that sends and receives business documents and data. Examples of such documents include bills of lading, manifests, shipping advice, price quotations, shipping instructions, licenses, insurance documents, customs declarations, and the like.

In system 10, client devices 30 and a messaging server 200 are connected via a communications network 50. The network 50 may also include other networkable devices known in the art, such as other client devices, servers, printers and storage media. It is well understood in the art, that any number or variety of computer networkable devices or components may be coupled to the network 50 without inventive faculty. Examples of other devices include, but are not limited to, servers, computers, workstations, terminals, input devices, output devices, printers, plotters, routers, bridges, cameras, sensors, or any other such device known in the art. Each of client devices 30A-F may be of any computing device known in the art that are able to communicate electronic documents on the network 50. In some embodiments, client devices 30A-F may generate, originate, or participate in the sharing of electronic documents with messaging server 200.

The network 50 connecting the client devices 30A-F and the messaging server 200 may be any communication network 50 known in the art, including the Internet, a local-area-network (LAN), a wide-area-network (WAN), or any system that links a computer to messaging server 200. Further, network 50 may be configured in accordance with any topology known in the art, including star, ring, bus, or any combination thereof.

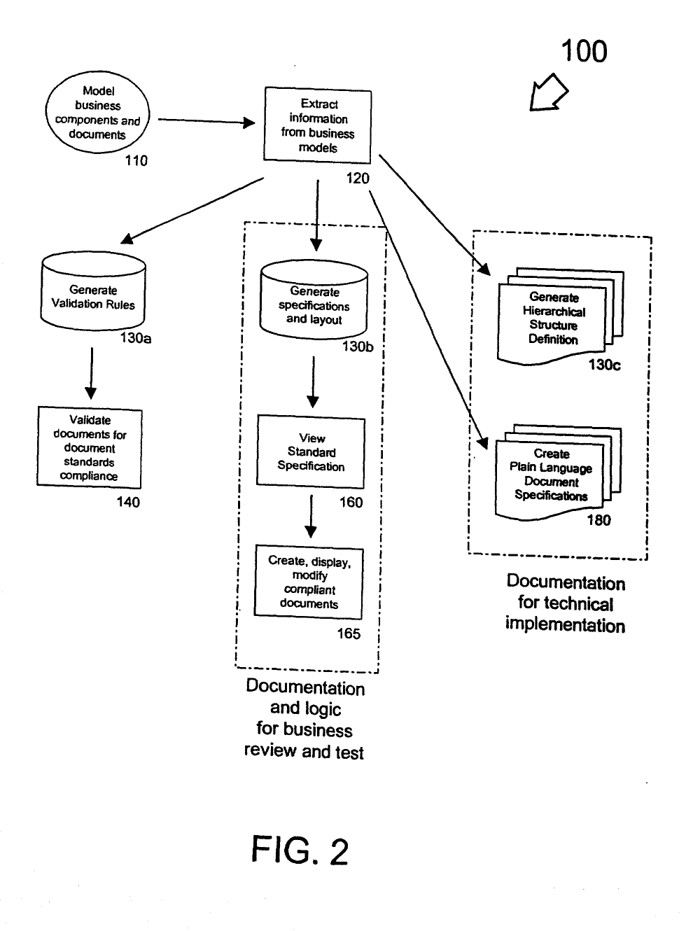

FIG. 2 is a simplified functional block diagram depicting process 100, constructed and operative in accordance with an embodiment of the present invention. Process 100 allows system 10 to communicate electronic documents and the information contained within such documents between client devices 30A-F. Process 100 facilitates the development, maintenance, understanding and enforcement of electronic data interchange standards that allows system 10 to communicate electronic documents and information container within such document between client devices 30A-F in an efficient manner.

Process 100 comprises a number of sub-processes. In sub-process 110, business components and documents are modeled using a modeling language. Once modeled, the models can be extracted, block 120, to generate Hierarchical Structure Definitions (HSDs), blocks 130, 130b, and 130c. A hierarchical structure definition (HSD) is a document specification that describes the structure and information format that define a document. Examples of HSDs include, but are not limited to, eXtensible Mark-up Language (XML) Document Type Definitions (DTD), XML schemas, Standard General Mark-up Language (SGML) schemas and the like.

Once generated, hierarchical structure definitions may be used a variety of ways. A client-messaging server 200 may be used as a public web-server, allowing the download of HSDs to those wishing to comply with the standards when exchanging business data electronically through system 10. Distributed to client devices 30A-F via a download, the HSDs can be viewed, block 160, and used to create, display, or modify documents compliant with the HSD, block 165.

These documents may then be distributed from one client device 30A to another 30B. Because the documents are compliant with a common HSD stored at a client messaging server 200, the information within the documents may be shared easily between multiple parties. When documents are distributed between parties, compliance with the HSD facilitates the sharing of information. More importantly, because documents described by HSDs are derived from a consistent business model, the information within the documents may be shared with other business documents. For example, information within a requisition form may then be shared with a request for quotation, a purchase order, a bill of lading, a customs declaration, and insurance documents.

A trusted third party, such as client messaging server 200, may be used to verify or validate that documents comply with the HSD, block 140. Client messaging server 200 may be used to provide security in data transactions, message delivery notification, message sequencing, document referencing, transaction orientation, document standards, title registry, and help process responsibility and liability insurance for clients using system 10. Moreover, by using system 10, clients may exchange documents using a simple, inexpensive, seamless, and robust standard.

Furthermore, information extracted from business models 120, may be used to generate HSD document specifications for those seeking to implement process 100, block 130c, or generate plain language document specifications block 180.

These sub-processes will be described in greater detail below.

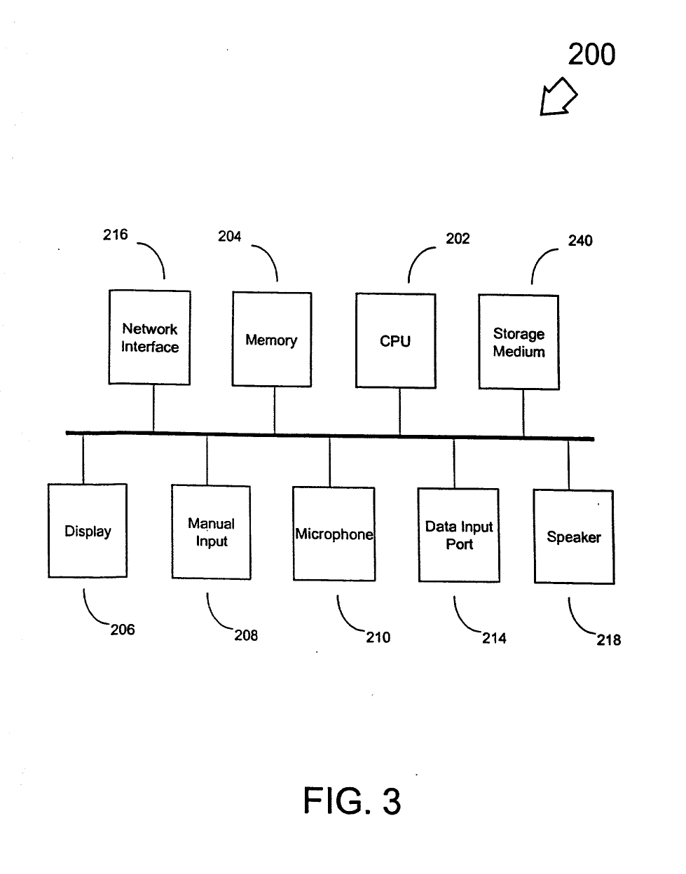

Embodiments will now be disclosed with reference to a functional block diagram of an exemplary messaging server 200 of FIG. 3. It is understood by those in the art that client devices 30, may be equivalent in functionality to messaging server 200 of FIG. 3. Messaging server 200 runs a multi-tasking operating system and includes at least one central processing unit (CPU) 202. CPU 202 may be any microprocessor or micro-controller as is known in the art. The software for programming the CPU 202 may be found at a computer-readable storage medium 240 or, alternatively, from another location across network 50. CPU 202 is connected to computer memory 204. Messaging server 200 is controlled by an operating system (OS) that is executed within computer memory 204.

CPU 202 communicates with a plurality of peripheral equipment, including network interface 216. Additional peripheral equipment may include a display 206, manual input device 208, storage medium 240, microphone 210, and data input port 214. Display 206 may be a visual display such as a cathode ray tube (CRT) monitor, a liquid crystal display (LCD) screen, touch-sensitive screen, or other monitors as are known in the art for visually displaying images and text to a user. Manual input device 208 may be a conventional keyboard, keypad, mouse, trackball, or other input device as is known in the art for the manual input of data. Storage medium 240 may be a conventional read/write memory such as a magnetic disk drive, magneto-optical drive, optical drive, floppy disk drive, compact-disk read-only-memory (CD-ROM) drive, digital video disk read-only-memory (DVD-ROM), digital video disk read-access-memory (DVD-RAM), transistor-based memory or other computer-readable memory device as is known in the art for storing and retrieving data. Significantly, storage medium 240 may be remotely located from CPU 202, and be connected to CPU 202 via a network such as a local area network (LAN), a wide area network (WAN), or the Internet.

Microphone 210 may be any suitable microphone as is known in the art for providing audio signals to CPU 202. In addition, a speaker 218 may be attached for reproducing audio signals from CPU 202. It is understood that microphone 210 and speaker 218 may include appropriate digital-to-analog and analog-to-digital conversion circuitry as appropriate.

Data input port 214 may be any data port as is known in the art for interfacing with an external accessory using a data protocol such as RS-232, Universal Serial Bus (USB), or Institute of Electrical and Electronics Engineers (IEEE) Standard No. 1394 (‘Firewire’).

Network interface 216 may be any interface as known in the art for communicating or transferring files across a computer network, examples of such networks include Transmission Control Protocol/Internet Protocol (TCP/IP), Ethernet, Fiber Distributed Data Interface (FDDI), token bus, or token ring networks. In addition, on some systems, network interface 216 may consist of a modem connected to the data input port 214.

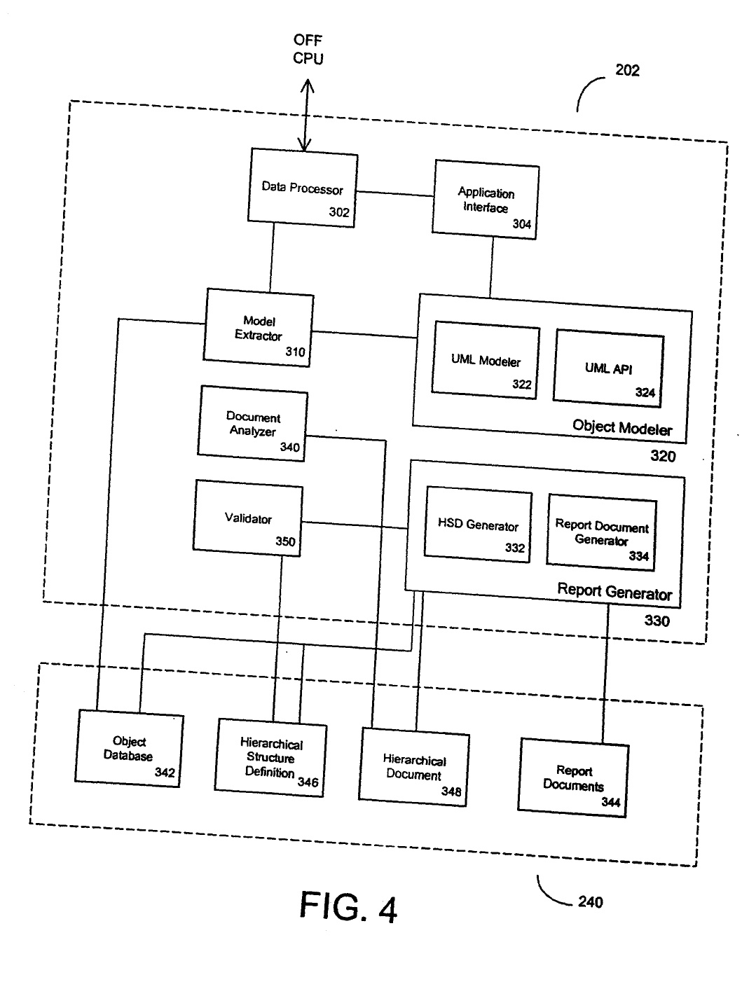

FIG. 4 is an expanded functional block diagram of CPU 202 and storage medium 240. It is well understood by those in the art, that the functional elements of FIG. 4 may be implemented in hardware, firmware, or as software instructions and data encoded on a computer-readable storage medium 240. As shown in FIG. 4, central processing unit 202 is functionally comprised of a data processor 302, an application interface 304, a model extractor 310, an object modeler 320, a report generator 330, a document analyzer, and a validator 350. Data processor 302 interfaces with display 206, manual input device 208, storage medium 240, microphone 210, data input port 214, and network interface 216. The data processor 302 enables CPU 202 to locate data on, read data from, and write data to, these components. In addition, the above functional components also generate intermediate or final results, such as object database 342, a hierarchical document 348, a hierarchical structure definition 346, and report documents 344.

Application interface 304 enables CPU 202 to take some action with respect to a separate software application or entity. For example, application interface 304 may take the form of a windowing user interface, as is commonly known in the art.

Object modeler 320 enables the modeling of business components in a modeling language, such as Unified Modeling Language (UML).

Object modeler 320 may be further comprised of a Unified Modeling Language modeler 322 and a Unified Modeling Language Application Programming Interface (API) 324.

Model extractor 310 is the structure that extracts information from a UML model derived from object modeler 320, and generates an object database 342. Object database 342 may be stored on storage media 240, and may comprise any object-oriented or relational database known in the art. For example, object database 342 may comprise various database tables. The outputs are used as input for other components, such as report generator 330.

Report generator 330 may comprise a hierarchical structure definition (HSD) generator 332 and a report document generator 334.

Report generator 330 takes the output of model extractor 310 and derives HSDs 346 and report documents 344. As discussed above, HSDs are document specifications that describe the structure and information format that define a document. HSDs may be used to generate documents compliant with the document described by the HSD, or as validation scripts to validate compliance with the business document model. Report documents 344 are plain-language descriptions of a document standard.

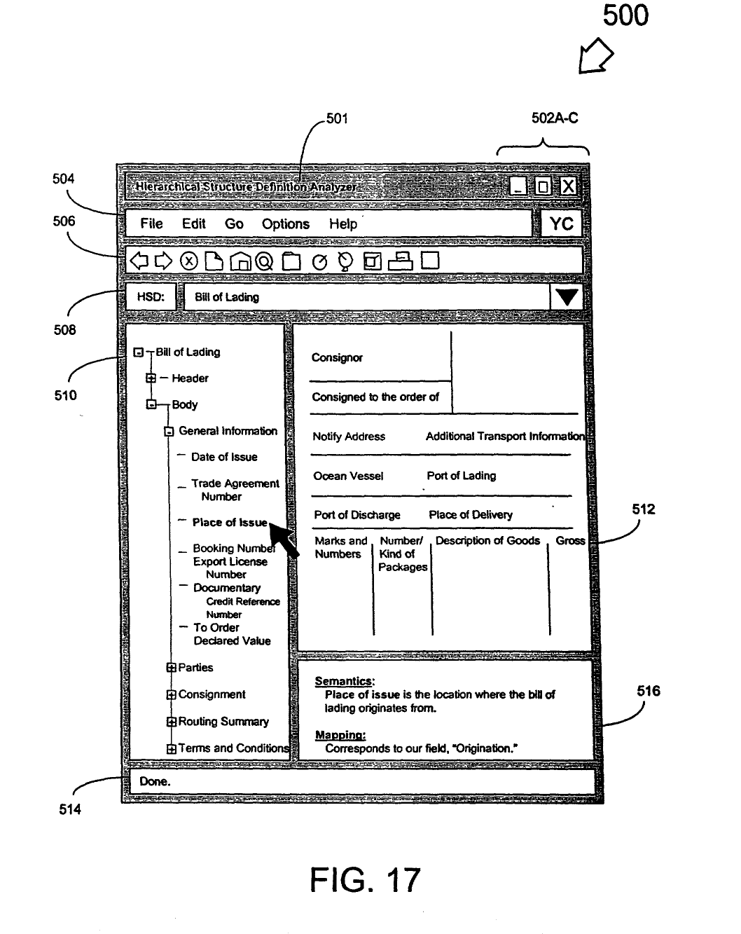

Document Analyzer 340 is a structure, that may be implemented in software, that allows processor 202 to generate a hierarchical document 348, defined as document compliant with a hierarchical structure definition 346. Additionally, document analyzer 340 may allow users of system 10 to view HSDs in a user-friendly graphical format. An example of such a document analyzer 340 window is shown in FIG. 17. Document analyzer window 500 comprises title bar 501, window control buttons 502A-C, menu bar 504, button bar 506, document address bar 508, HSD structure frame 510, graphical view frame 512, semantics frame 516 and status bar 514. Within the document analyzer window 500, the HSD structure frame 510 displays the hierarchical structure of an HSD being viewed by the document analyzer 340. The graphical view frame 512 displays a graphical view of a document that complies with the HSD. The semantics frame 516 allows a user to view the semantics and mapping related to an element of the HSD. As will be further described below, semantics are a read-only description of an HSD element, while mapping is a user-definable description of an HSD element.

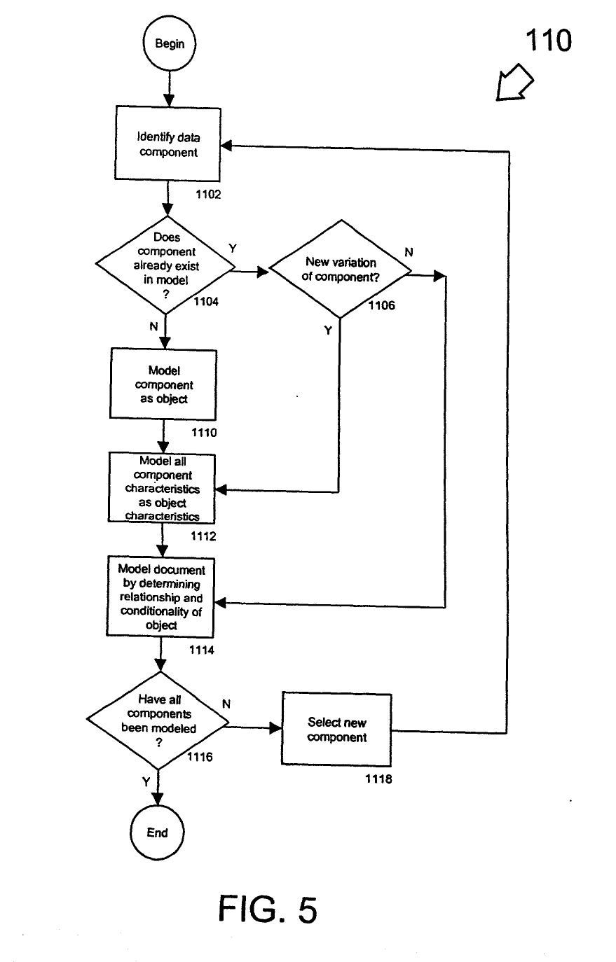

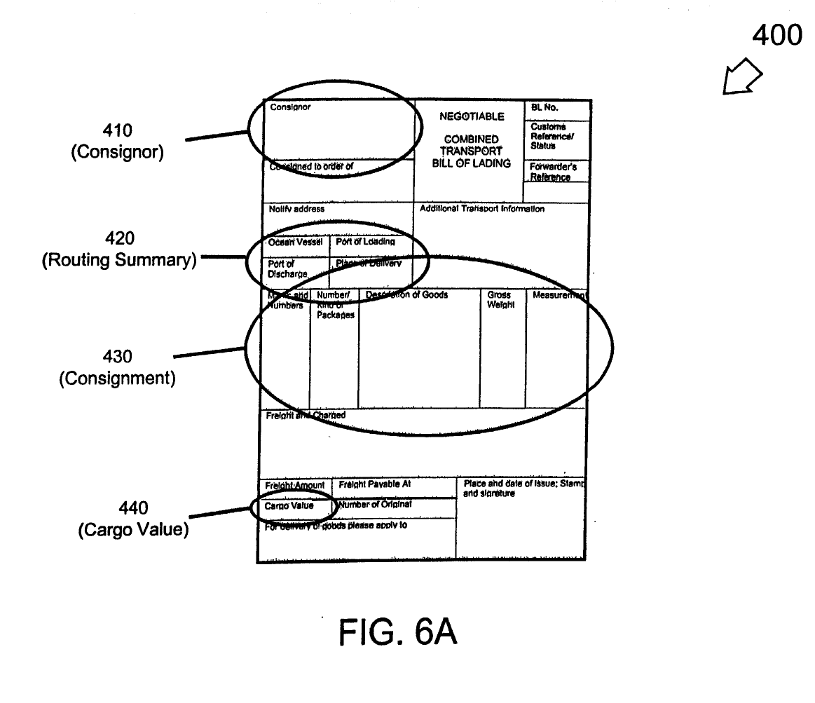

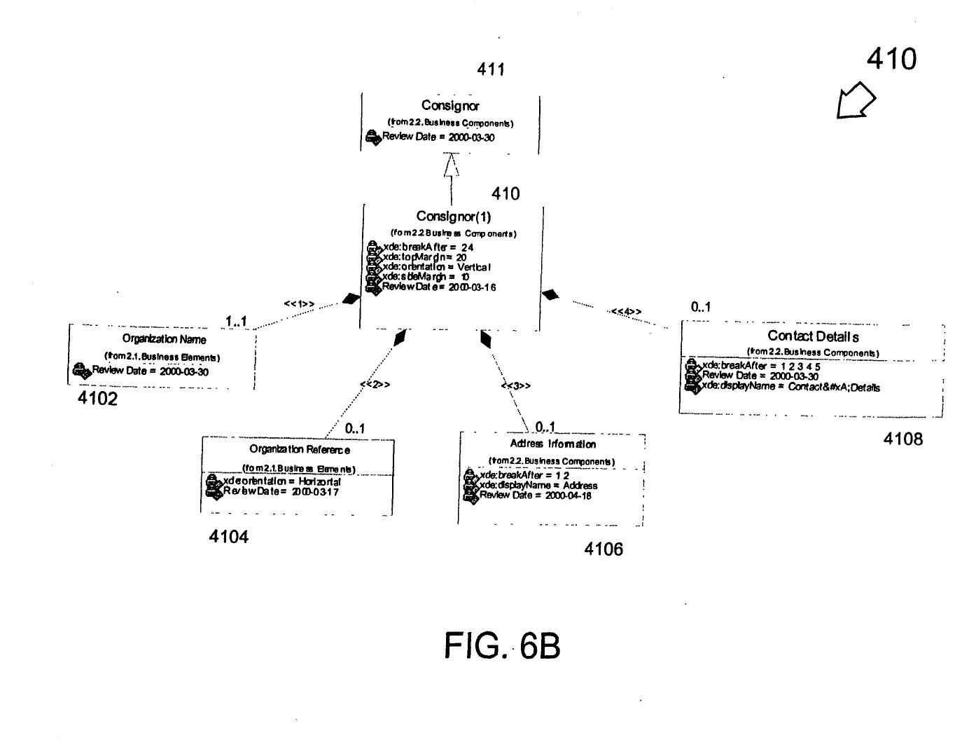

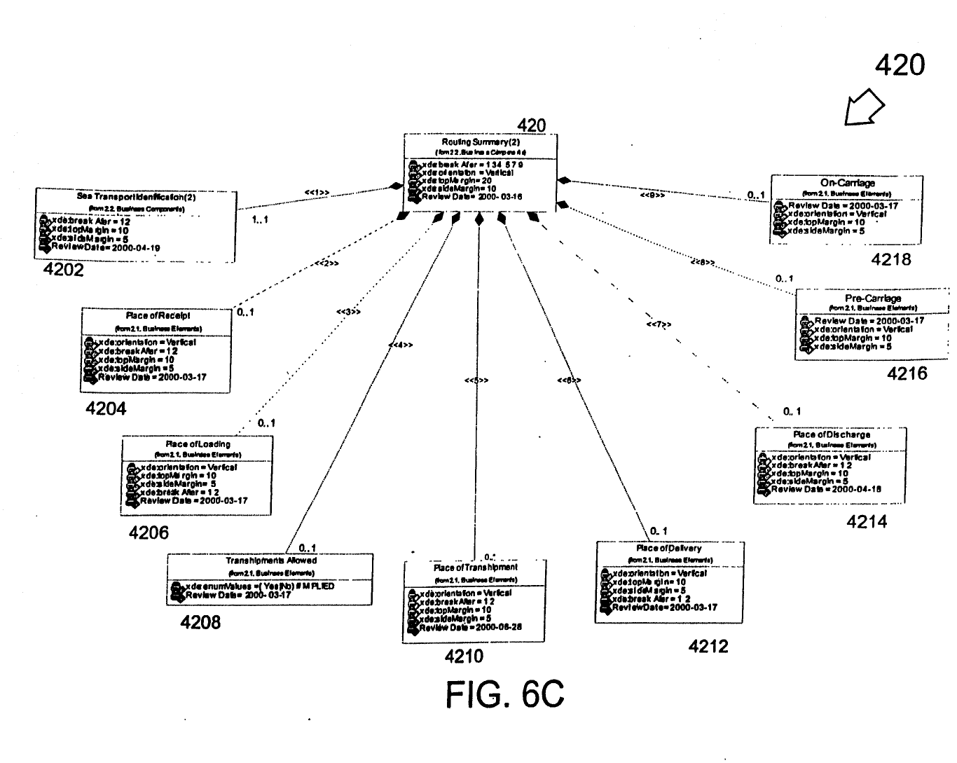

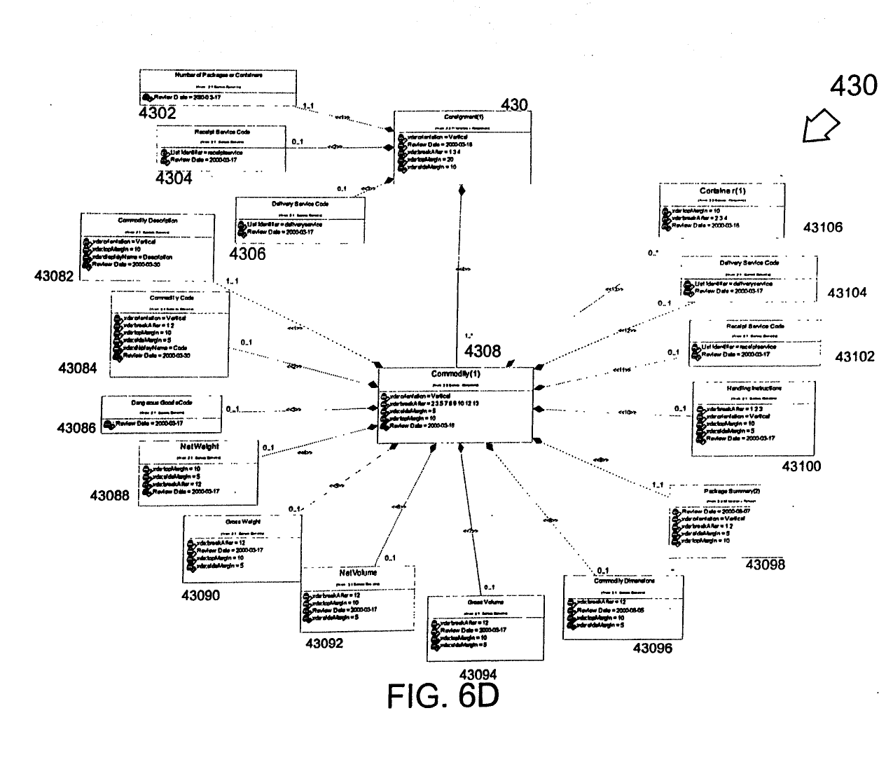

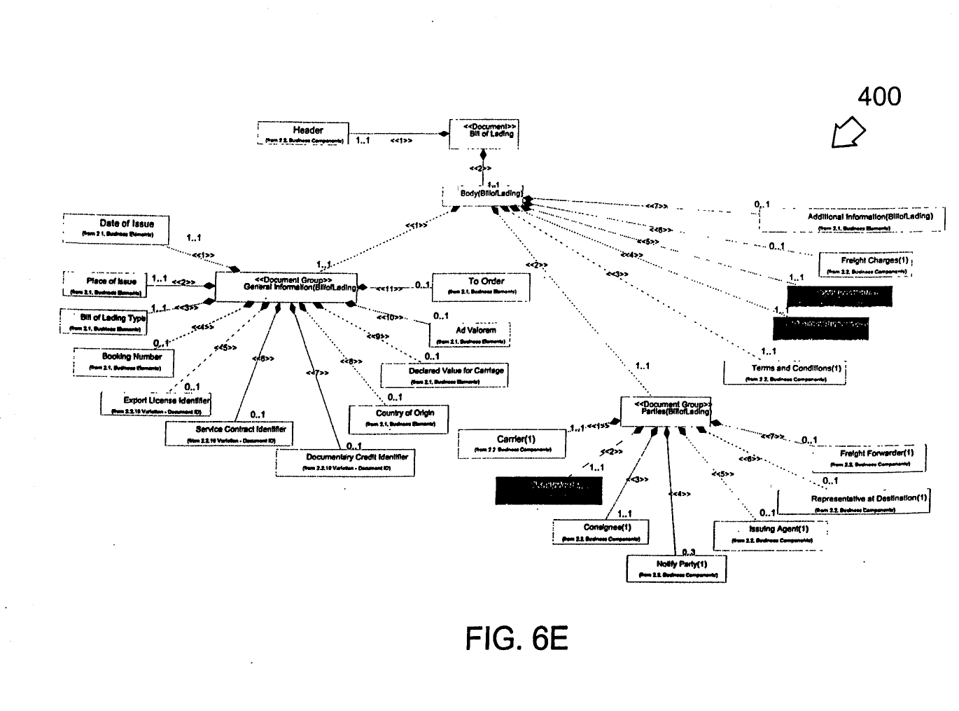

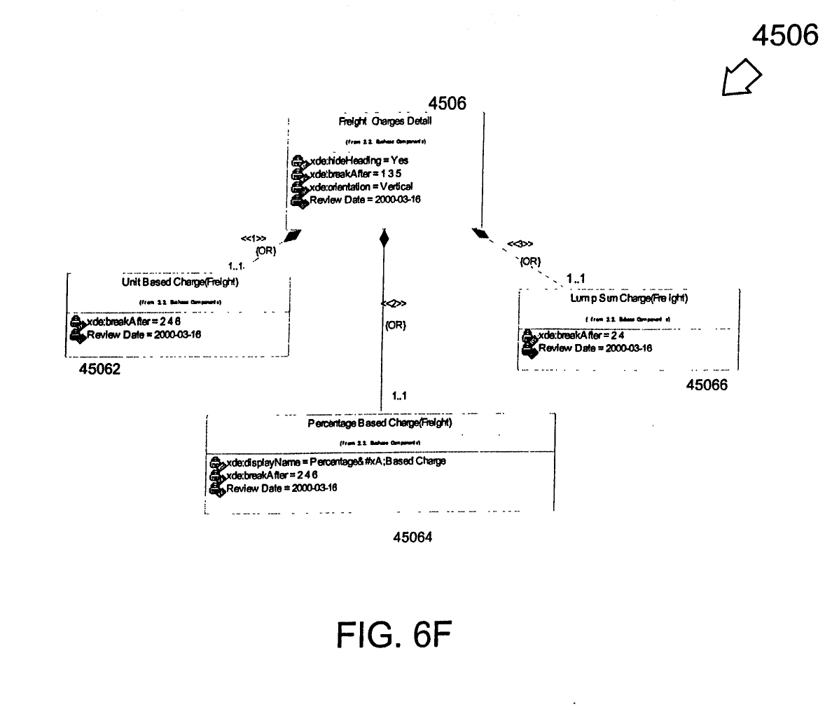

FIG. 5 is a flow diagram depicting sub-process 110, which models of business documents and objects. A business document is any document used in business. A business object is a discrete business component. For clarification purposes only, the following example will model an example document, a bill of lading 400, as depicted in FIG. 6A It is understood that the principles herein are extendable to business process and data models without inventive faculty.

In this illustration, the objects are modeled in Uniform Modeling Language. It is well understood in the art that the concepts may be modeled equally well using any object-oriented or relational modeling language, notation or framework. Examples of other applicable methods include Booch notation, Jacobson use-case analysis, Rumbauch analysis, Coad notation, Wirfs-Brock analysis, and design pattern analysis. Any modeling language able to house all definitions in a single repository can be used to ensure unambiguous data definitions and consistency across all documents 344.

At block 1102, model extractor 310 identifies a data component in the business process, business data, or document. In the modeling of business documents, it is useful to compare the commonalties between documents, so the common components may be modeled across documents.

When modeling common hierarchical business structures, such as documents, the sharing common component models helps the transfer of information from one document to another. As a consequence, it is helpful when objects and attributes are modeled in a fashion that are reusable. Applying this philosophy to Unified Modeling Language (UML), it is useful to model attributes and objects as UML classes, so that the common attributes and objects may be modeled across hierarchies in model packages. In some embodiments, the UML attributes are reserved for storing semantics, mapping, display information (such as display sequence numbers or display attributes that describe display layout). As is known in the art, UML attributes can not be reused across different classes; consequently, it beneficial to model data attributes as UML Classes and metadata (such as display attributes) of the data attributes, which do not need to be reused, as UML attributes.

In FIG. 6A, bill of lading 400 has numerous data components. These data components, include, amongst others, consignor information 410, routing summary information 420, and consignment information 430.

Once the data component has been identified, a determination must be made on whether the component already exists in the model, block 1104. If the component already exists, another determination must be made whether the component is a new variation of an existing component, block 1106. If so, no new object is created within a UML modeler 322, and flow continues at block 1112. If the component is not a new variation, flow continues at block 1114.

If the component does not already exist in the model, as determined by decision block 1104, flow continues at block 1110.

At block 1110, a class object is created to represent the component. The object created by using UML modeler 322. In modeling the object, the modeler determines the object data type.

Basic data types comprise the fundamental objects upon which all others are constructed. These objects describe the structure of the data, often for the benefit of technical understanding, and may not infer any business meaning. Examples of such basic data types are: integer, decimal, floating, Boolean, code, and string.

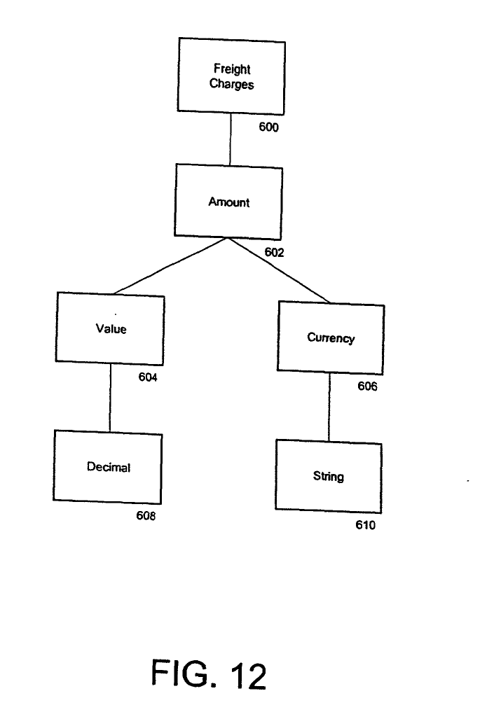

All data attributes of an object class must be defined by one of the basic data types. Composite data types are derived from the basic data types. These are normally used where two or more data attributes are required to represent a concept. Consider, for example, the data type “amount,” 602 shown in FIG. 12. Amount 602 is a concept with two data attributes (each represented as separate classes), “value” 604 and “currency” 606. Thus, to specify an amount 602, one must specify both a value 604 and currency 606 for the amount. Composite data types do not infer business meaning. (In turn, value is of basic type decimal, and currency is of basic type string.) Composite data types, which are generalizations of each basic data type, should be held in their own UML Modeling sub-package and diagram for ease of use and reference, as it increases its of use and referencing.

None of the data type objects may appear on any trade document. The data types are used in a “business elements” package. The data attributes of these business elements are “types of” or generalizations of the basic and composite data types.

The business elements are a first level in a model hierarchy at which business meaning is derived. They can be considered to be “business attributes” and can only be re-used to formulate the business components. Drawing on our previous example, consider the business element, “freight charges” 600. Freight charges 600 is a type of amount 602, but has a business meaning.

Business components are constructed from the business elements and can be considered as “business classes.” A business component reflects a concept that can have a number of variations that may appear on different documents.

All business components have an abstract class and have at least one variation of this abstract class. Each variation is modeled as a generalization or “type of” the abstract class.

At block 1112, all component characteristics are modeled as object characteristics or attributes. For example, as shown in FIG. 6B, consignor(1) 410 has the following attributes: organization name 4102, organization reference 4104, address information 4106 and contact details 4108. Similarly, routing summary (2) 420, shown in FIG. 6C, may comprise, sea transport identification(2) 4202, place of receipt 4204, place of loading 4206, transshipment allowed 4208, place of transshipment 4210, place of delivery 4212, place of discharge 4214, pre-carriage 4216, on-carriage 4218.

The business object attributes are contained within each variation. Common business attributes are associated to each variation separately.

At block 1114, the document as a whole can be modeled by determining the relationship, conditionality, and cardinality of objects and classes. For example, in FIG. 6D, consignment(1) 430 consists of number of packages or containers 4302, receipt service code 4304, delivery service code 4306, and one or more of a commodity(1) 4308. In turn, commodity(1) 4308 has attributes commodity description 43082, commodity code 43084, dangerous goods code 43094, net weight 43088, gross weight 43090, net volume 43092, gross volume 43094, commodity dimensions 43096, package summary(2) 43098, handling instruction 43100, receipt service code 43102, delivery service code 43104, container 43106. Similarly, as shown in FIG. 6E, bill of lading 400 is modeled in its entirety as relationships between object classes.

Non-document classes are found in the business data model only. These classes describe a concept, a term, or an assumption that has meaning for the business context but which would not be directly conveyed in the document models. These classes are important as they denote a relationship to other classes in use, but they are not used themselves in the trade documents. An example is the concept of a trade, a valid concept but which is not explicitly found on any of the document definitions that have been modeled.

Abstract classes illustrate relationships and dependencies between classes. Abstract classes are used on a business model to illustrate a concept without any document or context specificity. The abstract class consignor 411 is used on the business model to denote the high level concept, whereas consignor(1) 410 may be a variation needed directly on a document model for a specific context.

An abstract class has no “contained within” or aggregation relationship with another object. As this model is depicting high-level relationships between objects, it is not relevant to describe generalizations, aggregations or cardinality rules. These are applied during the documentation of all associated data attributes.

In embodiments that use UML, both data classes and data attributes may be defined as UML classes to facilitate the reuse of attribute definitions across business components.

Business attributes may be defined in a business elements package. Objects defined in this package do not have other objects in an aggregate relationship to them. An object may be considered to be a business attribute when it only has one aggregate relationship.

Circular references and multiple inheritances are not used during the modeling because of the ambiguity inferred from document definitions. Such references invalidate the integrity of a hierarchical model. However, intentionally recursive, also called reflexive references may be modeled. In such cases, object constraint language may be used to indicate the desired, reflexive references. In some embodiments, a UML stereo type may be used to model a recursive relationship.

At decision block 1116, it is determined whether all components have been modeled. If not, a new component is selected at block 1118, and flow resumes at block 1102. Otherwise, the sub-process ends when all components have been modeled in UML.

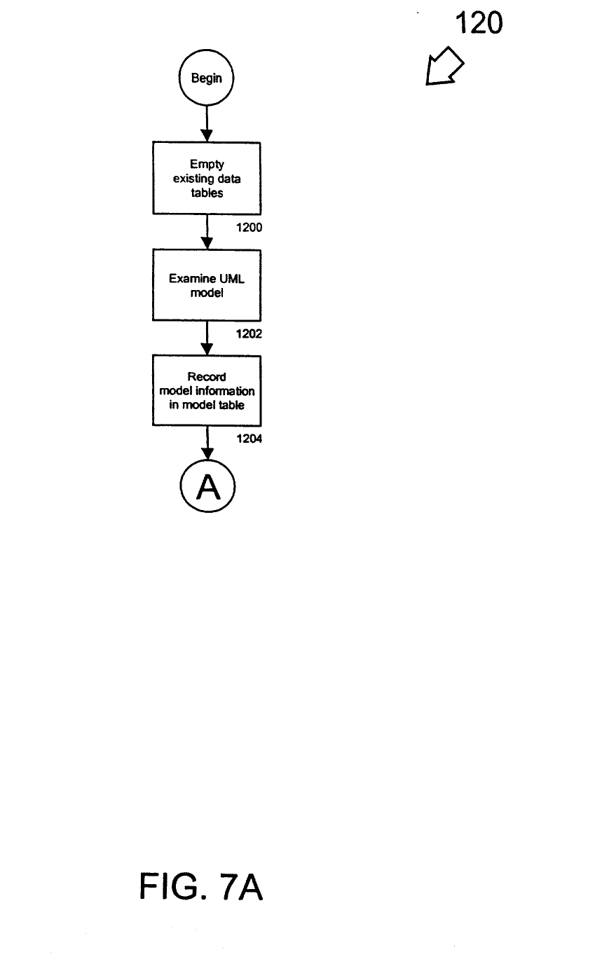

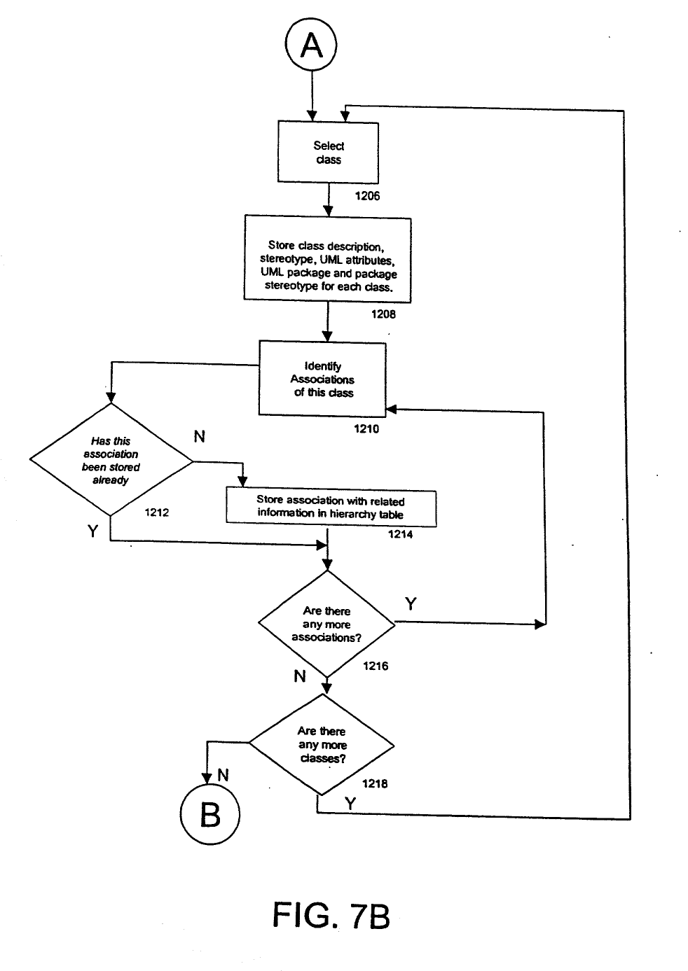

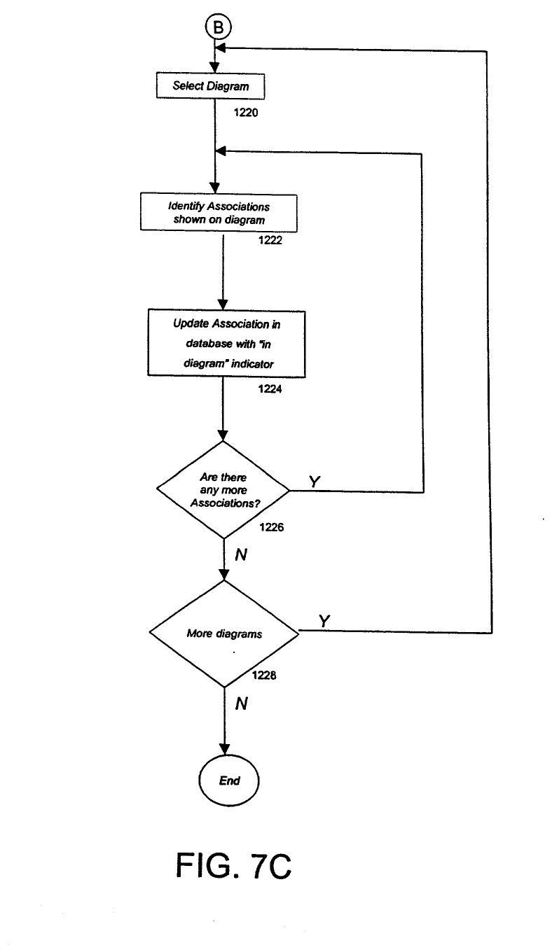

Moving to FIG. 7A, sub-process 120, constructive and operative in accordance with an embodiment of the present invention, extracts the UML model and produces object database 342 as output. In addition, in some embodiments, sub-process 120 may also identify and remove redundant objects in the UML model, validate compliance with hierarchical structure, and report on the impact of changes on the model on individual document standards for version control. Object database 342 may then be used to construct hierarchical structure definition validation scripts, business standards, documents, and document specifications.

At block 1200, existing models stored in object database 342 tables are emptied, moved, or saved for comparison purposes. This is done to avoid mixing older models with newer models.

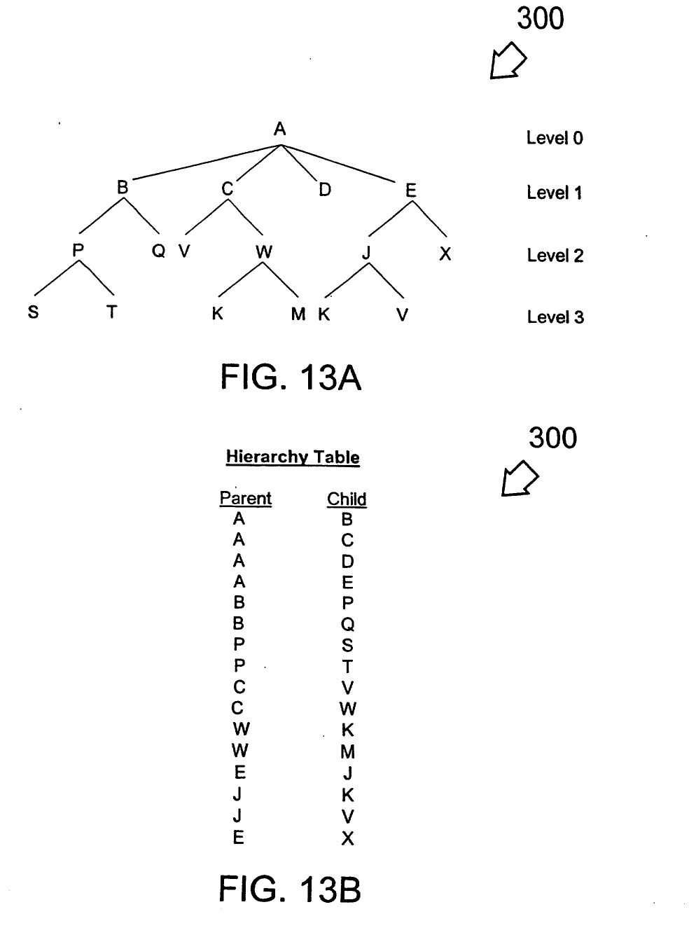

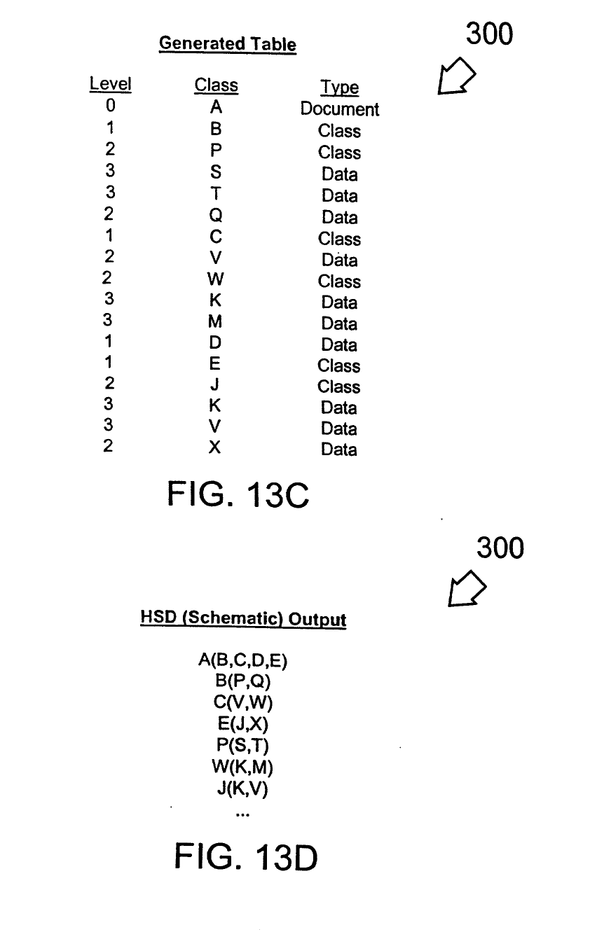

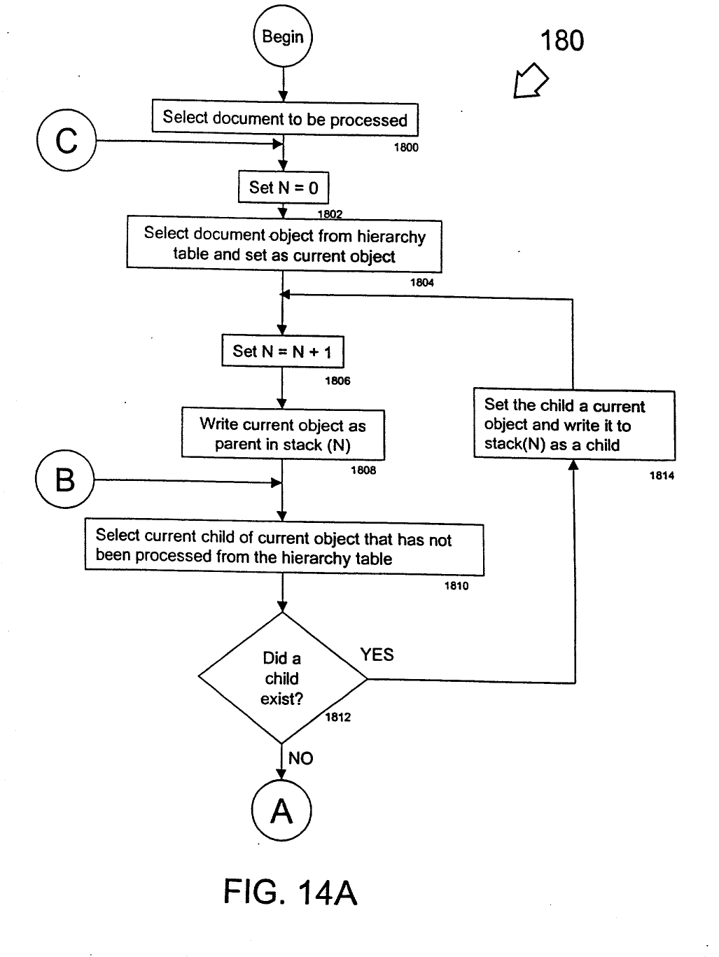

At block 1202, model extractor 310 examines the UML model. Model extractor 310 identifies an object and its characteristics and the model information is stored within a model hierarchy table, block 1204. An example of a model hierarchy 300 and a resulting hierarchy table are shown in FIGS. 13A-B.

Moving to FIG. 7B, a class in the model is selected, block 1206. The class description, stereotype, attributes, package, and package stereotype for each class is stored within the object database, block 1208. In some embodiments, models may also have sequence numbers attached to a class and its class siblings. The sequence numbers indicate the order in which peer or sibling classes should appear in the HSD. Sequence numbers are actually related to the associations (see <<1>>, <<2>> on FIG. 6B), but they indicate the order of the classes.

Class associations for the selected class are identified at block 1210.

If the association has already been stored within the hierarchy table, as determined by block 1212, flow continues on at 1216. Otherwise, the association, with related information, is stored in the hierarchy table, at block 1214. An example hierarchy table is shown in FIG. 13B.

At decision block 1216, another determination must be made any more associations exist. If so, flow returns to block 1210. If not, flow continues at decision block 1218.

If there are more classes, as determined by decision block 1218, flow returns to block 1206. Otherwise, flow continues at block 1220 on FIG. 7C.

At blocks 1220-1228, the model diagram depicting the entire model is used to remove redundancies from by determine whether objects in the UML model are used. The diagram is selected at block 1220. The objects shown in the diagram are identified, at block 1222, and the objects stored within database is updated with a flag indicating that the object is in a diagram, block 1224. Objects that do not have a flag indicating that they are used in a diagram are identified and removed from the UML model manually.

If there are any more objects, determined by block 1226, flow returns to block 1222.

If there are any more diagrams, as determined by block 1228, flow returns to block 1220. Otherwise, flow ends for sub-process 120.

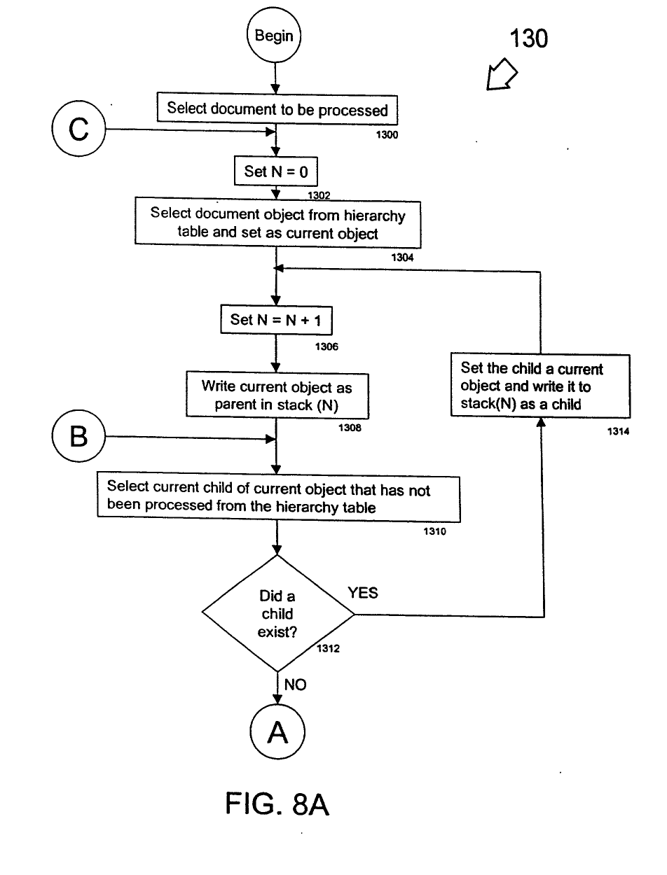

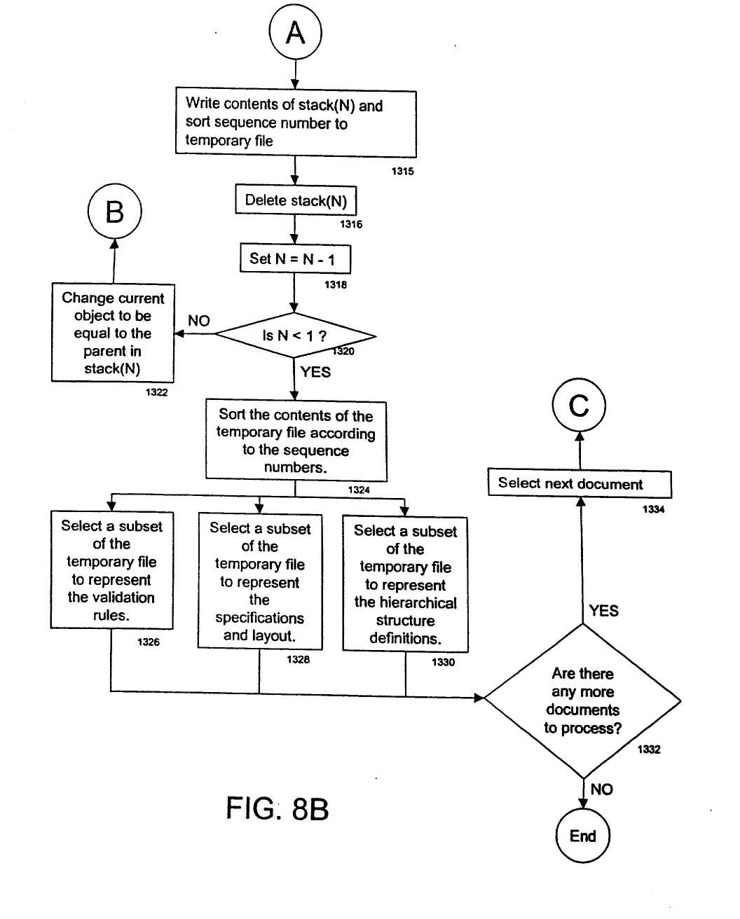

At FIG. 8A, sub-process 130, constructive and operative in accordance with an embodiment of the present invention, takes a model stored in object database 342 and creates a hierarchical structure definition. To do this, sub-process takes information from the object database 342 hierarchy table (as depicted in FIG. 13B), pushes the information on to a stack, as shown in the generated table (depicted in FIG. 13C), and generates the HSD elements from the generated table. The HSD can be used to validate compliance of a document with a model (sub-process 130a), used to help generate new documents specifications and layout (sub-process 130b), or used as a document reference (sub-process 130c). As mentioned above, in some embodiments, the HSD may be an XML Document Type Definition (DTD), used to verify the compliance of XML and plain language documents with a document model defined by the validation script. Yet in other embodiments, the HSD may be an XML schema or any other document structural definition as is known in the art.

At block 1300, report generator 330 selects a document to be processed into an HSD. At block 1302, a stack counter is set to zero. A document object is then selected from the document hierarchy table and set as the current object, at block 1304. The stack counter is incremented at block 1306, and the current object is written as a parent object in the stack, block 1308. Process 130 then selects a child object of the current object from the hierarchy table.

If a child object exists, then the child is set as the current object, and the child is written to the stack as a child at block 1314. Flow returns to block 1306.

If no child object exists, flow continues at block 1315 on FIG. 8B.

At block 1315, the current contents of the stack are written to a temporary file and sorted by its stack depth or “level.” The current stack contents are deleted, and the stack pointer is decremented, blocks 1316 and 1318.

If the stack pointer is less than one, entire class tree has been processed, and flow continues at block 1324.

If the stack pointer is not less than one, entire class tree has not been processed, the current object is changed to be equal to the parent in stack depth, block 1322, and flow returns to block 1310.

At block 1324, the HSD generator sorts the contents of the temporary file according to output sequence numbers generated by the process to enable sorting of the final output according to the syntax rules of the HSD. At blocks 1326, 1328, and 1330, the HSD generator 332 generates the individual HSD element corresponding to the identified objects in the temporary file. For the most part, blocks 1326, 1328, and 1330 operate similarly, incorporating optional information to facilitate other sub-processes. Block 1330 (sub-process 130c) generates a standard HSD. Block 1326 (sub-process 130a) incorporates standard HSD elements with data type information for validation. Block 1328 (sub-process 130b) generates standard HSD elements, data type information, semantic descriptions of the generated HSD elements, and layout information; results of block 1328 are used for viewing by a document analyzer 340.

An HSD element defines a template for an HSD document, identifying the information, indicating whether information is mandatory or optional, how and where the information appears, and how the HSD elements relate to each other. In some embodiments the HSD element is a DTD element, while in other embodiments the HSD element is an element of an XML schema.

The structure of the actual HSD element may vary from implementation to implementation. In one embodiment, all the HSD document definitions have a common structure consisting of two components, a document header and a document body.

The document header summarizes the contents of the document. In some embodiments, the document header can be used as a protocol data unit (PDU) sent between client devices 30. The formatting of the document header may vary from implementation to implementation. Information found within a document header may include: a document identifier, a document type, document status (such as “Final” or “Draft”), a version, and a document type description.

The document body is the part of the document that contains the business data specific to the document type. The structure of the document body is therefore different for each document definition.

In embodiments that use XML DTDs as HSDs, all information contained within the document is treated as XML elements. Using XML elements ensures consistency. Rather than mixing elements and attributes it is simpler only to use elements. Moreover, a variety of XML tools do not support XML attributes. Finally, the use of elements allows us to distinguish between data and metadata (e.g. formatting information) in a simple and consistent manner. XML elements are handled consistently across a variety of XML parsers. Since XML attributes are not handled consistently in all XML parsers, some embodiments of system 10 use XML attributes to store system 10 specific information, such as display attributes, semantics, and mapping information.

At decision block 1332, it is determined whether all documents in the database model are processed. If not, a new document is selected, at block 1334, and flow returns to block 1302.

If the documents are processed, sub-process 130 ends.

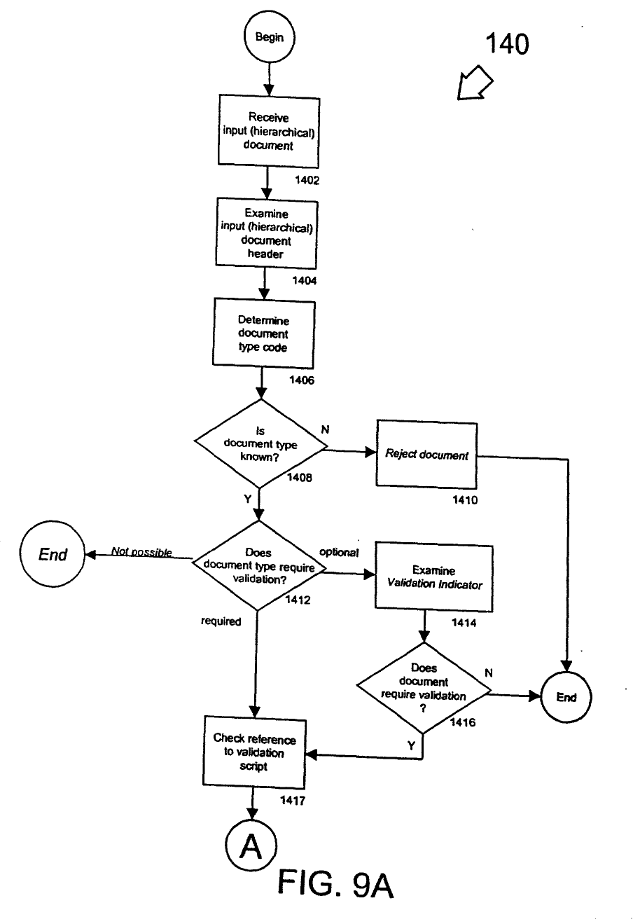

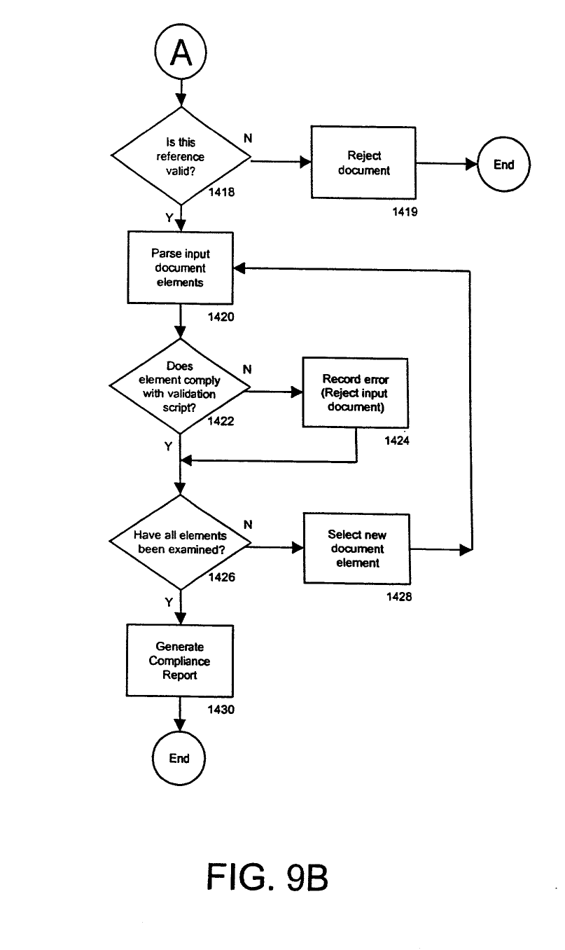

At FIG. 9, sub-process 140, constructive and operative in accordance with an embodiment of the present invention, verifies the compliance of a document with UML document model by comparing the document with an HSD validation script generated by sub-process 130.

At block 1402, validator 350 receives the input hierarchical document. This input document is the document to be validated. The validator 350 examines the document header to determine the document type code, blocks 1404-1406. As described above, the document header contains information about the document.

If the document type is not known at decision block 1408, the document is rejected at block 1410, and the sub-process ends.

If the document type is known at decision block 1408, the validator 350 determines whether the document type requires validation, or whether the validation is optional, or not possible, decision block 1412.

If validation is not possible, the sub-process ends.

If validation is required, the flow continues at block 1417.

If validation is optional, the validator 350 looks for a validation indicator 1414. A validation indicator is any indicator that indicates whether a validation should be performed. Examples of validation indicators include the document source (originator), predetermined validation requests, or any set of rules indicating a validation should be performed. At decision block 1416, the validator 350 determines whether a validation should be performed using the status of the validation indicator. If no validation is required, the sub-process ends. Otherwise, flow continues at block 1417.

At block 1417, the validator 350 checks the document header reference to a HSD validation script, and flow continues at block 1418 on FIG. 9B.

Moving to FIG. 9B, at block 1418, the validator 350 determines whether the document header reference is valid, i.e. whether the HSD being referred to exists. If the reference is invalid, the document is rejected at block 1419, and the sub-process ends.

If the reference is valid, the input document elements are parsed, block 1420. A comparison, by validator 350, is made to the validation script to determine whether the element complies with the validation script at decision block 1422. If the element does not comply, the non-compliance error is recorded at block 1424. In some embodiments, the input document would be rejected.

At decision block 1426, it is determined whether all elements in the document have been examined. If not, a new element is selected, at block 1428, and flow returns to block 1420.

If the objects are identified, a compliance report is generated by validator 350, listing the compliance or instances of non-compliance by the document.

Sub-processes 130b, 160, and 165 are used in conjunction with viewing and editing documents. These sub-processes link configuration attributes and other meta-data, such as document layout information with the document elements. This allows objects that are common to multiple documents to appear in the same way, when displayed by an editor practicing embodiments of these sub-processes. For example, consignment(1) 430 would appear in the same layout on a shipping instruction as on bill of lading 400, assuming that the same configuration attributes are used.

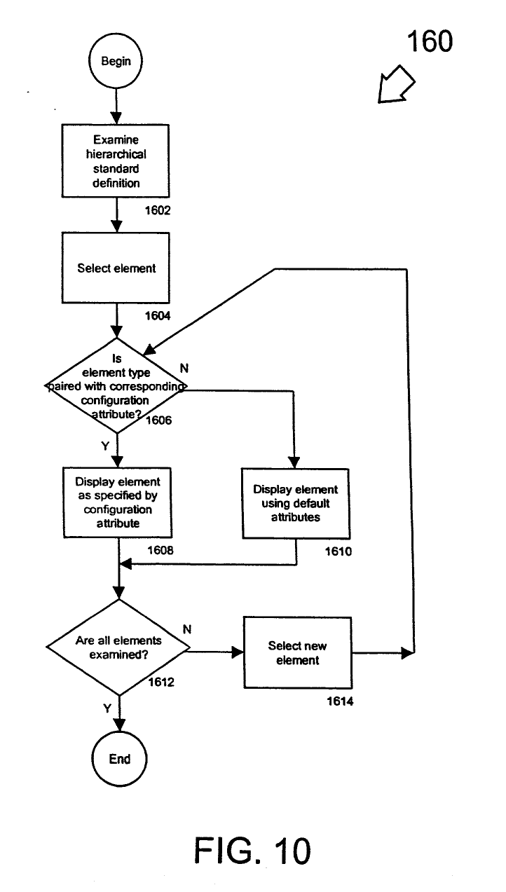

Constructive and operative in accordance with an embodiment of the present invention, sub-process 160, shown in FIG. 10, executed by the document analyzer 340 graphical view frame 512. Within the graphical view frame 512, document analyzer 340 displays the documents elements, depending upon the paired configuration attribute, if any. Note that the display of the document may also occur on monitor display 206, or in printed form.

At block 1602, document analyzer 340 examines a standard display attribute specification. The standard display attribute specification details “default” attributes to be used when an element is not paired with a corresponding display attribute.

A document element is selected at block 1604. If the element type has been paired with a corresponding configuration attribute, as determined by block 1606, the element is displayed as specified by the configuration attribute, at block 1608. In embodiments where XML DTDs are used, configuration attributes may be stored as DTD attributes. Otherwise, if the element has not been paired with a corresponding configuration attribute, the element is displayed using default attributes, at block 1610.

At decision block 1612, it is determined whether all elements in the document have been examined. If not, a new object is selected, at block 1614, and flow returns to block 1606.

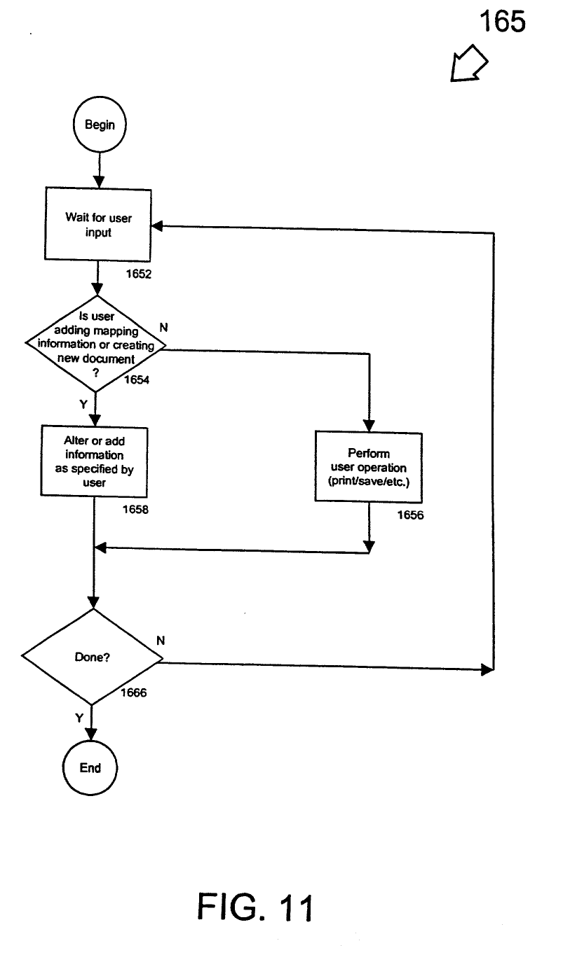

FIG. 11 illustrates sub-process 165, constructive and operative in accordance with an embodiment of the present invention, which maintains the proper display of document elements within a graphical view frame 512 while the user is adding mapping information, creating a new document, or copying from one document to another.

At block 1652, application interface 304 waits for user input.

When user input is entered, a determination is made whether the user is adding mapping information, creating a new document, or copying from one document to another. If not, the user operation is performed, block 1656. Such operations include printing, saving, reviewing document specifications, opening and closing elements of a hierarchical structure definition tree (as shown in a HSD structure frame 510), exporting mapping data to a text file (for import to a spreadsheet or another tool for further manipulation), or any other such operation. Flow then continues at block 1666. If the user is adding mapping information, creating a new document, or copying from one document to another, modification is performed on the affected elements, block 1658. It is understood that in some instances, modification may include adding or deleting instances of document elements.

At decision block 1666, it is determined whether user has completed the modification process (terminated the editor program). If not, flow returns to block 1652.

At FIG. 14A, sub-process 180, constructive and operative in accordance with an embodiment of the present invention, takes a model stored in object database 342 and creates a plain language document specification report document 3481. To do this, sub-process 180 takes information from the object database 342 hierarchy table (as depicted in FIG. 13B), pushes the information on to a stack, as shown in the generated table (depicted in FIG. 13C), and a plain language description from the generated table.

At block 1800, report document generator 334 selects a document to be processed into an HSD. At block 1802, a stack counter is set to zero. A document object is then selected from the document hierarchy table and set as the current object, at block 1804. The stack counter is incremented at block 1806, and the current object is written as a parent object in the stack, block 1808. Sub-process 130 then selects a child object of the current object from the hierarchy table at block 1810.

If a child object exists as determined by block 1812, then the child is set as the current object, and the child is written to the stack as a child at block 1814. Flow returns to block 1806.

If no child object exists, flow continues at block 1815 on FIG. 14B.

At block 1815, the current contents of the stack are written to a temporary file and sorted by its stack depth or “level.” The current stack contents are deleted, and the stack pointer is decremented, blocks 1816 and 1818.

If the stack pointer is less than one, entire class tree has been processed, and flow continues at block 1824.

If the stack pointer is not less than one, entire class tree has not been processed, the current object is changed to be equal to the parent in stack depth, block 1822, and flow returns to block 1810.

At block 1824, the report document generator 334 sorts the contents of the temporary file according to output sequence numbers generated by the process to enable sorting of the final output. At blocks 1826, the report document generator 334 generates plain text description of the UML element.

At decision block 1832, it is determined whether all documents in the database model are processed. If not, a new document is selected, at block 1834, and flow returns to block 1802.

If the documents are processed, sub-process 180 ends.

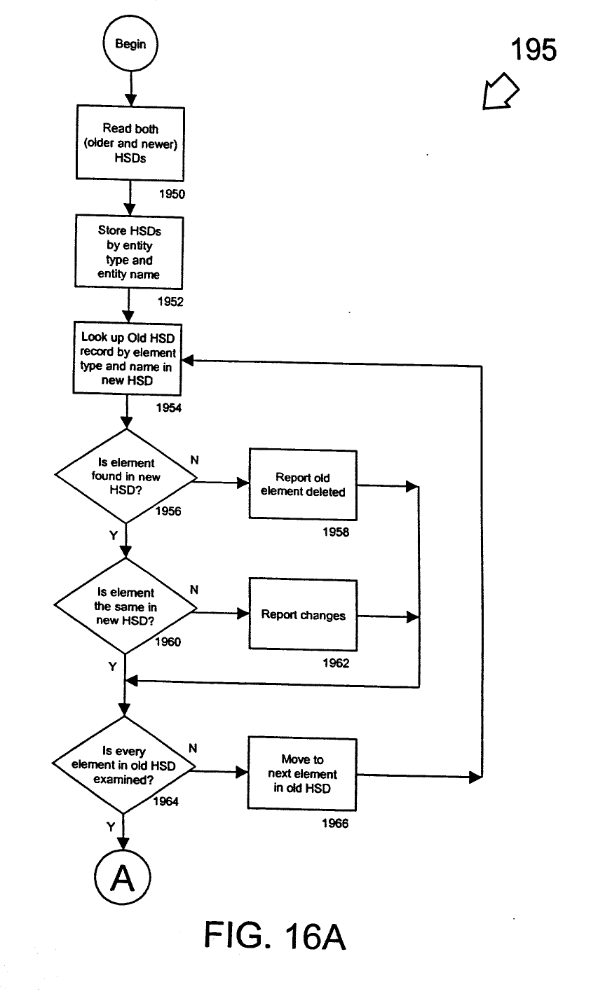

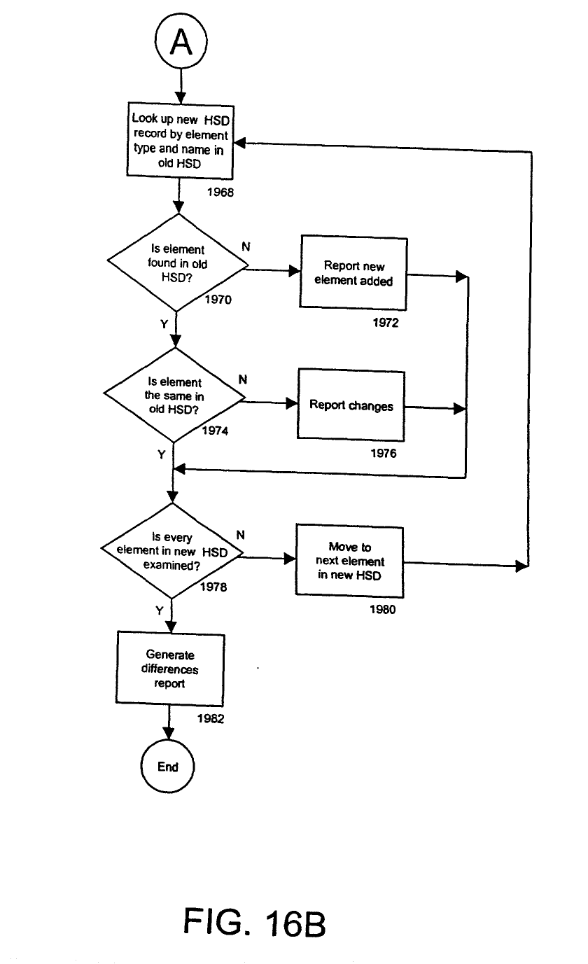

Constructive and operative in accordance with an embodiment of the present invention, sub-process 195, shown in FIG. 16A, compares two HSDs, referred to as an “older” and “newer” HSDs.

At block 1950, both the older and newer HSDs, are read by sub-process 195. The HSDs are stored in an object database 342, block 1952.

At blocks 1954-1966, the elements of the old HSD are compared with the new HSD.

At decision block 1956, sub-process 195 searches for an old element in the new HSD. If the element is not found, it is reported as “deleted” at block 1958, and flow continues at block 1964. If the old element is found in the new HSD, sub-process 195 determines whether it is the same in the new HSD. If not, it is reported as “changed” at block 1962, and flow continues at block 1964.

At block 1964, it is determined whether all elements in the document have been examined. If not, a new object is selected, at block 1966, and flow returns to block 1954.

At blocks 1968-1980, the elements of the new HSD are compared with the old HSD.

At decision block 1968, sub-process 195 searches for a new element in the old HSD. If the element is not found, it is reported as “a new added element” at block 1972, and flow continues at block 1978. If the new element is found in the old HSD, sub-process 195 determines whether it is the same in the old HSD. If not, it is reported as “changed” at block 1976, and flow continues at block 1978.

At block 1978, it is determined whether all elements in the document have been examined. If not, a new object is selected, at block 1980, and flow returns to block 1968.

All changes are then generated as part of a differences report at block 1982.

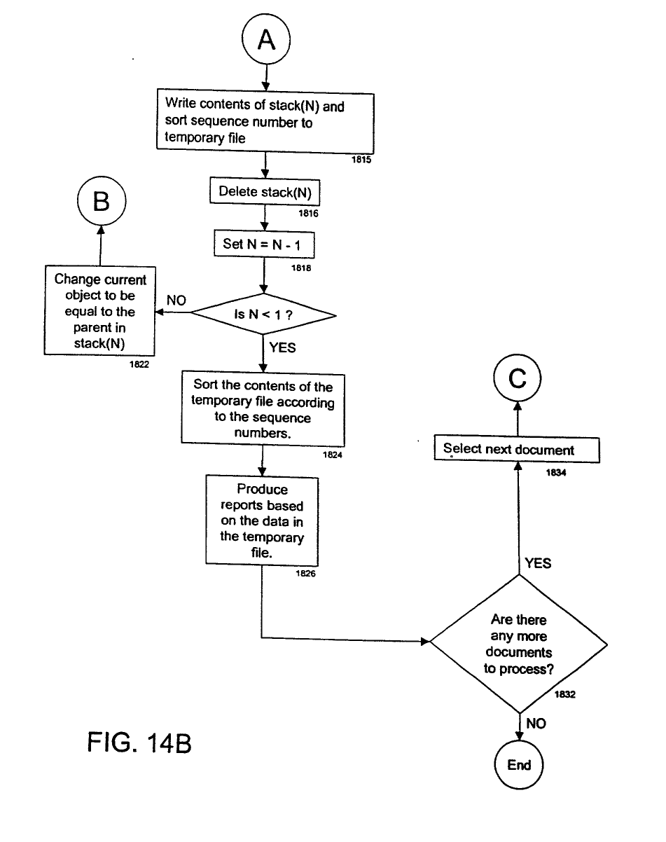

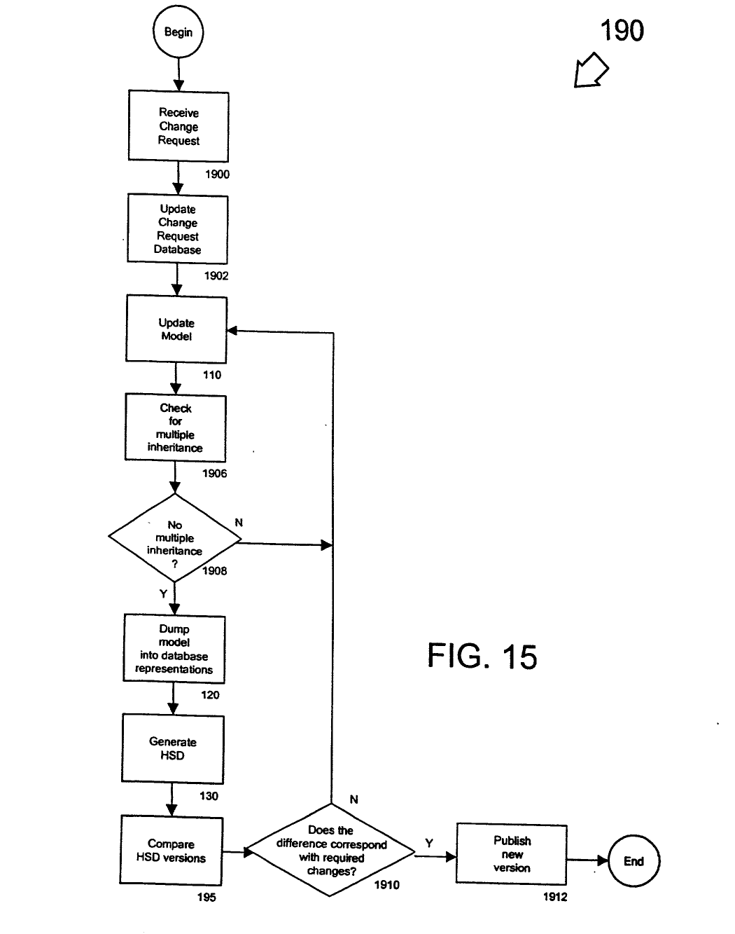

Constructive and operative in accordance with an embodiment of the present invention, sub-process 190, shown in FIG. 15, performs a version control function to help maintain the integrity of business models and HSDs generated by process 110-130.

At block 1900, a change request is received. The change request is logged in a change request database, which can be object database 342, at block 1902. The business model is updated as described by sub-process 110.

The model is checked to verify that no multiple inheritance exists within the business model, blocks 1906-1908.

The model is then extracted into a database representation, as described by sub-process 120.

The HSD is generated, as described by sub-process 130.

The new HSD is compared with a previous (non-change request) version of the HSD, as described by sub-process 195.

At decision block 1910, a determination is made whether the difference corresponds to the required changes to the model, as recorded in the change request database. If the changes do not correspond, flow returns to block 110. Otherwise, the new HSD version is published and distributed at block 1912.

The previous description of the embodiments is provided to enable any person skilled in the art to practice embodiments of the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. A system comprising:
a first client device;
a second client device;
a messaging server connected to the first and second client devices via a communications network, the messaging server receiving an electronic document intended for the second client device from the first client device, verifying that the electronic document complies with a business document model, and forwarding the electronic document to the second client device when the compliance with the business document model is verified.

2. The system of claim 1 wherein the business document model is a hierarchical structure definition.

3. The system of claim 2 wherein the hierarchical structure definition is an eXtensible Markup Language Document Type Definition comprising Document Type Definition elements.

4. An apparatus comprising:
an object modeler;
a model extractor, coupled to the object modeler, that extracts a document model from the object modeler into an object database as a hierarchy table;
a report generator, that generates a hierarchical structure definition from the hierarchy table in the object database.

5. The apparatus of claim 4, further comprising:
a document analyzer allows the creation of a hierarchical document based on the hierarchical structure definition.

6. The apparatus of claim 5, further comprising:
a validator that validates the compliance of the hierarchical document with the hierarchical structure definition.

7. A method comprising:
modeling business documents in a modeling language as a business document model;
generating a hierarchical structure definition from the business document model.

8. The method of claim 7, wherein the modeling language is Uniform Modeling Language.

9. The method of claim 8, wherein the hierarchical structure definition is an eXtensible Markup Language Document Type Definition comprising Document Type Definition elements.

10. The method of claim 8, wherein the hierarchical structure definition is an eXtensible Markup Language schema.

11. A method comprising:
generating a hierarchical document from a hierarchical structure definition;
sending the hierarchical document to a client device or messaging server.

12. The method of claim 11, wherein the hierarchical structure definition is an eXtensible Markup Language Document Type Definition comprising Document Type Definition elements.

13. The method of claim 11, wherein the hierarchical structure definition is an eXtensible Markup Language schema.

14. A method comprising:
receiving a hierarchical document from a first client device destined for a second client device;
comparing the hierarchical document with a hierarchical structure definition;
validating the hierarchical document if the hierarchical document matches the hierarchical structure definition;
forwarding the hierarchical document to the second client device if the hierarchical document is validated.

15. The method of claim 14, wherein the hierarchical structure definition is an eXtensible Markup Language Document Type Definition comprising Document Type Definition elements.

16. The method of claim 14, wherein the hierarchical structure definition is an eXtensible Markup Language schema.

17. A method comprising:
catagorizing business objects in a business model;
representing variations of common business objects in the business model;
defining data classes and attributes of business objects with in the business model;
extracting the business model into an object database;
generating a hierarchical structure definition.

18. The method of claim 17, wherein the hierarchical structure definition is an eXtensible Markup Language Document Type Definition comprising Document Type Definition elements.

19. The method of claim 17, wherein the hierarchical structure definition is an eXtensible Markup Language schema.

20. The method of claim 18 further comprising:
coupling configuration attributes with the Document Type Definition Elements as Document Type Definition attributes.

21. The method of claim 20 further comprising:
displaying the hierarchical structure definition based on the coupled configuration attributes.

22. A computer readable medium, encoded with data and instructions, that when executed by a computer is caused to perform processes comprising:
modeling business documents in a modeling language as a business document model;
generating a hierarchical structure definition from the business document model.

23. The computer readable medium of claim 22, wherein the modeling language is Uniform Modeling Language.

24. The computer readable medium of claim 23, wherein the hierarchical structure definition is an eXtensible Markup Language Document Type Definition comprising Document Type Definition elements.

25. The computer readable medium of claim 23, wherein the hierarchical structure definition is an eXtensible Markup Language schema.

26. A computer readable medium, encoded with data and instructions, that when executed by a computer is caused to perform processes comprising:
generating a hierarchical document from a hierarchical structure definition;
sending the hierarchical document to a client device or messaging server.

27. The computer readable medium of claim 26, wherein the hierarchical structure definition is an eXtensible Markup Language Document Type Definition comprising Document Type Definition elements.

28. The computer readable medium of claim 26, wherein the hierarchical structure definition is an eXtensible Markup Language schema.

29. A computer readable medium, encoded with data and instructions, that when executed by a computer is caused to perform processes comprising:
receiving a hierarchical document from a first client device destined for a second client device;
comparing the hierarchical document with a hierarchical structure definition;
validating the hierarchical document if the hierarchical document matches the hierarchical structure definition;
forwarding the hierarchical document to the second client device if the hierarchical document is validated.

30. The computer readable medium of claim 29, wherein the hierarchical structure definition is an eXtensible Markup Language Document Type Definition comprising Document Type Definition elements.

31. The computer readable medium of claim 30, wherein the hierarchical structure definition is an eXtensible Markup Language schema.

32. A computer readable medium, encoded with data and instructions, that when executed by a computer is caused to perform processes comprising:
catagorizing business objects in a business model;
representing variations of common business objects in the business model;
defining data classes and attributes of business objects with in the business model;
extracting the business model into an object database;
generating a hierarchical structure definition.

33. The computer readable medium of claim 32, wherein the hierarchical structure definition is an eXtensible Markup Language Document Type Definition comprising Document Type Definition elements.

34. The computer readable medium of claim 32, wherein the hierarchical structure definition is an eXtensible Markup Language schema.

35. The computer readable medium of claim 33 farther comprising:
coupling configuration attributes with the Document Type Definition Elements as Document Type Definition attributes.

36. The computer readable medium of claim 35 farther comprising:
displaying the hierarchical structure definition based on the coupled configuration attributes.

37. A method comprising:
receiving a hierarchical structure definition comprising objects represented by hierarchical structure definition elements with configuration attributes and semantics corresponding to the hierarchical structure definition elements, the hierarchical structure definition elements having a hierarchical structure;
displaying the hierarchical structure of the hierarchical structure elements;
displaying the objects depicted as configured by the configuration attributes; and
displaying the semantics.

38. The method of claim 37, further comprising:
allowing the addition or editing of mapping information corresponding to the objects.

39. The method of claim 38, wherein the hierarchical structure definition is an eXtensible Markup Language Document Type Definition and the hierarchical structure definition elements are Document Type Definition elements.

40. The method of claim 38, wherein the hierarchical structure definition is an eXtensible Markup Language schema and the hierarchical structure definition elements are eXtensible Markup Language elements.

41. A computer readable medium, encoded with data and instructions, that when executed by a computer is caused to perform processes comprising:
receiving a hierarchical structure definition comprising objects represented by hierarchical structure definition elements with configuration attributes and semantics corresponding to the hierarchical structure definition elements, the hierarchical structure definition elements having a hierarchical structure;
displaying the hierarchical structure of the hierarchical structure elements;
displaying the objects depicted as configured by the configuration attributes; and
displaying the semantics.

42. The computer readable medium of claim 41, further comprising:
allowing the addition or editing of mapping information corresponding to the objects.

43. The computer readable medium of claim 41, wherein the hierarchical structure definition is an eXtensible Markup Language Document Type Definition and the hierarchical structure definition elements are Document Type Definition elements.

44. The computer readable medium of claim 41, wherein the hierarchical structure definition is an eXtensible Markup Language schema and the hierarchical structure definition elements are eXtensible Markup Language elements.
